(19) United States
(12) Patent Application Publication
(10) Pub. No.: US 2006/0243545 A1
(43) Pub. Date: Nov. 2, 2006

(54) BRAKE DEVICE SCHEME FOR GENERATING FEEDBACK POWER

(76) Inventor: Yu-Yu Chen, Sanchong City, Taipei County (TW)

Correspondence Address: PAI PATENT & TRADEMARK LAW FIRM, 1001 FOURTH AVENUE, SUITE 3200, SEATTLE, WA, 98154, US

(21) Appl. No.: 11/308,713

(22) Filed: Apr. 25, 2006

(30) Foreign Application Priority Data
Apr. 29, 2005 (TW) 94113802

(51) Int. Cl. B60L 7/10

(52) U.S. Cl. 188/164; 188/160; 188/162

(57) ABSTRACT

A brake device scheme for regemerating feedback power is essentially composed of a copper damping wheel and a magnetically controlled damper. The damping wheel is rotating to cut into the slot of the damper to induce a varying eddy current whose value is depending on how deep it cuts into the slot thereof so as to damp the motor rotation with different generating braking power without the aid of any external power supply thereby the size of the mechanism can be minimized and the production cost curtailed.

### BACKGROUND OF THE INVENTION

1. Field of the Invention

The present invention relates to a brake device scheme for generating feedback power, and more particularly, to a compact, simply constructed, and mechanically stable brake device scheme equipped in gymnastic facilities such as an exertion velocipede able to automatically regenerate feedback power to contribute as braking power or for surface board instrumentation use.

2. Description of the Prior Art

A convention at brake device scheme for generating feedback power in a gymnastic facility such as an exertion velocipede generally serves in the form of oil pressure, frictional, or motor-generator type. Among them the oil pressure type is notorious for oil leakage, high noise, and low efficiency under a high temperature. The frictional type is unstable, and the motor-generator type has its inherent disadvantages of complicated structure and high cost.

The braking power which contributes as a load for operating an electrical gymnastic facility is normally caused by an electro-magnetic damping force arising from a varying strength of magnetic field. It is well known that a conducting material induces an eddy current when cutting across the fluxes of a magnetic field, and the eddy current induces another magnetic field with fluxes against the original ones thereby producing a mechanical force resisting the applied force so as to serve as a load for the player of the gymnastic facility.

However, every kind of electro-magnetic brake device has its particular advantages and disadvantages. The most popular one consists of a cast iron rotor and a stator. The stator consists of more than two pieces of arcuate brake plate each provided with more than one pair of arcuate permanent magnetic poles facing to the inner side of the cast iron rotor rim with a air gap formed therebetween. As the cast iron rotor rotates, its mechanical rotational force is resisted by the opposing braking force produced by the cast iron rotor cutting the magnetic fluxes across the air gap. The smaller the air gap is the larger the braking or damping force to rotor rotation will be, and vice versa. However, it is noticed that the most problematic shortcoming of such brake device scheme lies in the fact that if the arcuate brake plate is placed too close to the cast iron rotor, a great electro-magnetic damping force will be produced when pulling out the brake plate causing the work difficult to perform. The recent examples of such category can be observed in the invention disclosed by the U.S. Pat. No. 5,437,353 and the Taiwan New Utility Model No. 380.789.

In the conventional brake device scheme, the aforesaid air gap is adjusted manually by pulling a rope to vary distance between the permanent magnetic poles on the arcuate brake plate and the rim of the cast iron rotor so as to adjust the mechanical braking force. It should be noted that the distance between the permanent magnetic poles on the arcuate brake plate and the rim of the cast iron rotor is not uniformly changed when pulling the rope since the arcuate permanent magnetic poles do not displace as a whole but there exist partially differences resulting in difficulty to maintain a stable braking force. Such a brake device scheme can only be used in a rather inexpensive product without calling for high precisement.

If an electrical control is introduced instead of the manual form, an outer power supply source will be necessary to actuate a driving motor, for this, the installation of the facilities has to be limited to a place where there is an available external power source, but obviously the size of the gymnastic facilies becomes bulky with an ugly appearance.

An electro-magnetic control is a preferable selection. Even so as high magnetic excitation current is required for building up a strong magnetic field which leads to consumption of a large amount of electricity. Besides, the control condition in a high temperature environment will become unstable, and a complicated structure leads to raise the production and upkeep cost.

For these shortcomings noticeable on the prior art, an improvement is seriously required.

In view of the foregoing situation, the applicant herein conducted an intensive research based on many years of experience gained through professional engagement in the manufacturing of related products, with continuous experimentation and improvement finally culminating in the development of the improved brake device scheme for generating feedback power which will be disclosed herein.

### SUMMARY OF THE INVENTION

Accordingly, the main object of the present invention is to provide a brake device scheme for generating feedback power, and which is simply constructed, mechanically stable to be equipped in gymnastic facilities such as an exertion velocipede to produce regenerative feedback power suitable for mass production with a low cost.

To achieve the above object, the present invention provides a copper damping wheel having at least a rotor, a permanent magnet, a stator, one or more than one magnetic field winding, and a cast copper rotating part. Even pairs of N/S permanent magnet poles are disposed staggeringly along the annular edge of the rotor; while a plurality of magnetic field windings are formed o the stator. An electro-motive force is induced when the rotor rotates in the magnetic field built up by the stator. An alternating current corresponding to the induced electro-motive force flows through a rectifier and motor control circuit wherein it is converted into a direct current and then fed into a motor circuit to drive the motor which in turn drives the cast copper rotating part to rotate.

The copper damping wheel is placed in the slot of a magnetically controlled damper to vary the electro-magnetic damping force according to the depth of the mutually cutting portion between a pair of intensive magnet formed on the walls of an magnetically controlled damper and the copper damping wheel so as to control the rotating speed of the rotor. The larger the aforesaid mutually cutting depth, the stronger the electro-magnetic damping power is generated by the brake device contributing as a load for the user of the gymnastic facilities.

The electro-magnetic control form for supplying regenerative feedback braking power described above is very efficient and effective in reducing the mechanical wear of the facilities so as to prolong their lifespan.

### BRIEF DESCRIPTION OF THE DRAWINGS

The above object and other advantages of the present invention will become more apparent by describing in detail the preferred embodiments of the present invention with reference to the attached drawings in which:

FIG. 1 is a front view of the brake device scheme of the present invention.

FIG. 1A is an enlarged schematic view of the magnetically controlled damper according to the present invention.

FIG. 1B is a lateral view of the brake device scheme of the present invention.

FIG. 2A to FIG. 2C are the first to third illustrative views in order when the magnetically controlled damper is turned to the left direction.

FIG. 3A to FIG. 3C are the first to third illustrative views in order when the magnetically controlled damper is turned to the right direction.

FIG. 4A to FIG. 4C are three illustrative views showing the up and down movement of the magnetically controlled damper.

FIG. 5 is the electrical circuit diagram of the rectifier and motor control circuit according to the present invention.

FIG. 6 and FIG. 6a are respectively the front and the lateral views of the brake device scheme according to a second embodiment of the present invention.

FIG. 7 and FIG. 7A are respectively the front and the lateral vies of the brake device scheme according to the third embodiment of the present invention.

FIG. 8 and FIG. 8a are respectively the front and the lateral views of the brake device scheme according to a fourth embodiment of the present invention.

FIG. 9 and FIG. 9a are respectively the front and the lateral views of the brake device scheme according to a fifth embodiment of the present invention.

FIG. 10 and FIG. 10A are respectively the front and the lateral views of the brake device scheme according to a sixth embodiment of the present invention.

### DETAILED DESCRIPTION OF THE PREFERRED EMBODIMENTS

Now the present invention will be described in detail with reference to the accompanied drawings hereinafter.

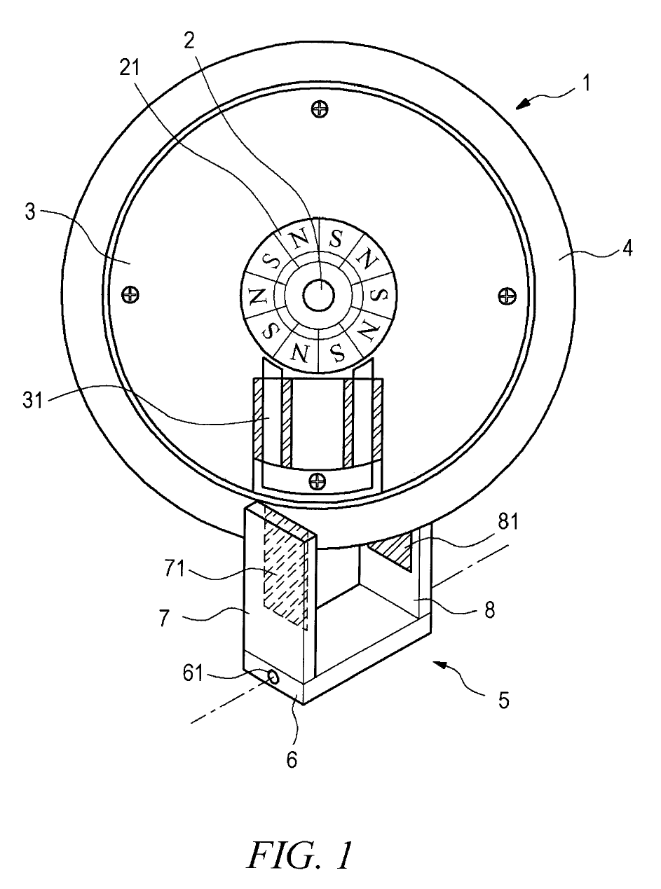

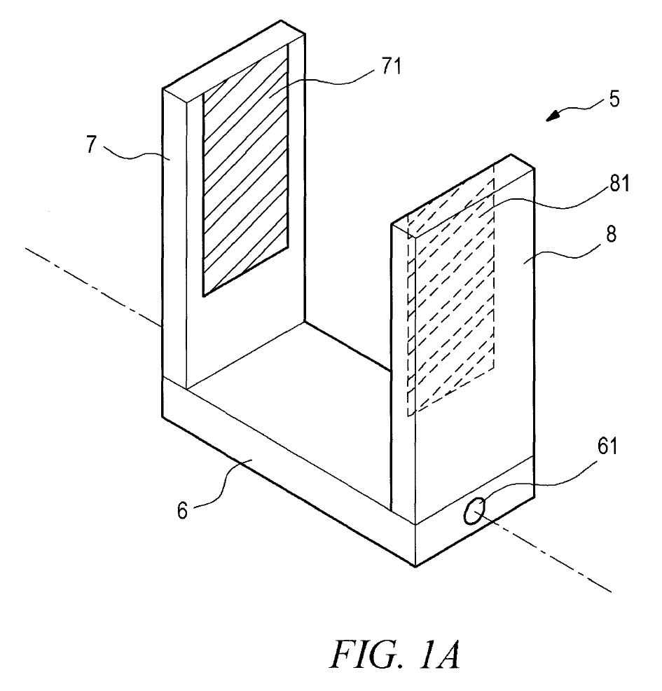

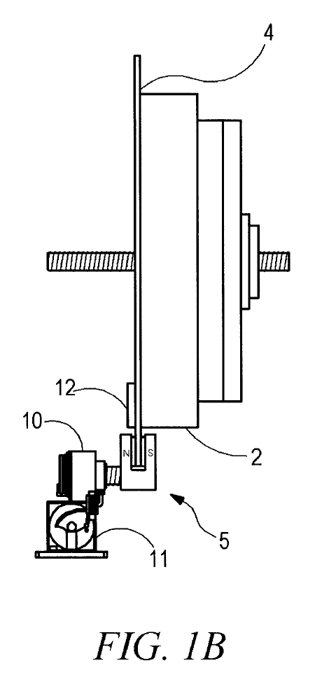

Referring to FIGS. 1, 1A and 1B, the brake device scheme of the present invention comprises a copper damping wheel 1, a magnetically controlled damper 5, a power and motion transmission gear 10, a motor 11, and a rectifier and motor control circuit 12.

The damping wheel 1 consists of a rotor 2, a permanent magnet 21, a stator 3, several magnetic field windings 31 formed on the stator 3, and a cast copper rotating part 4. Even number of pairs of N/S permanent magnet poles 21 are disposed in staggering way along the annular edge of the rotor 2. A back elecro-motive force (emf) is induced in the rotor 2 when it rotates to cut the fluxes of the magnetic field built up by the field windings 31 formed on the stator 3. An alternating current corresponding to the induced emf flows through the rectifier and motor control circuit 12 wherein it is converted into a direct current and then fed into a motor circuit to drive the motor 11 which in turn actuates the magnetically controlled damper 5 to make an angular displacement to some extent through the power and motion transmission gear 10. The cast copper rotating part 4 follows the rotation of the rotor 2.

The magnetically controlled damper 5 is composed of a base 6, a base axis 61, a left wall 7, a right wall 8, a left intensified magnet 71, and a right intensified magnet 81. The left wall 7 is erected at the left side of the base 6; while the right wall 8 at the right side thereof such that the magnetically controlled damper 5 is configurated into a slot shaped structure. The left intensified magnet 71 is attached to the inner surface of the left wall 7; while the right intensified magnet 81 attached to the inner surface of the right wall 8. The base axis 61 passing longitudinally through the center of base 6 from right to left serves as a reference axis for the magnetically controlled damper 5 to turn to make an angular displacement.

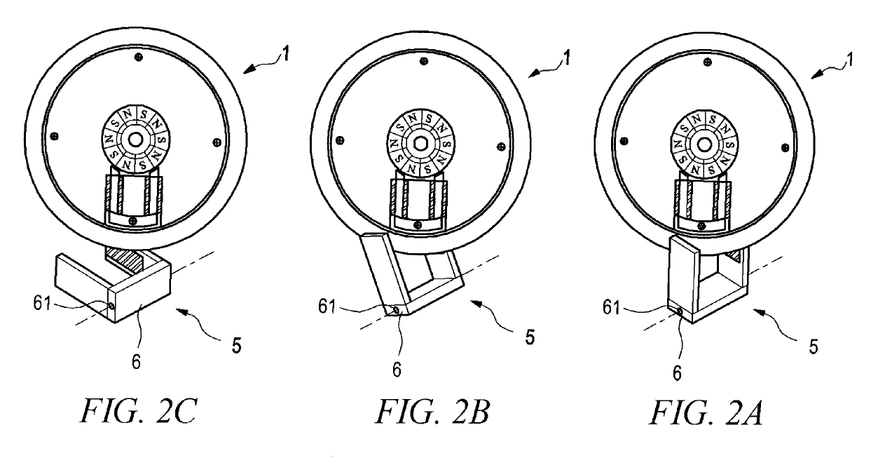

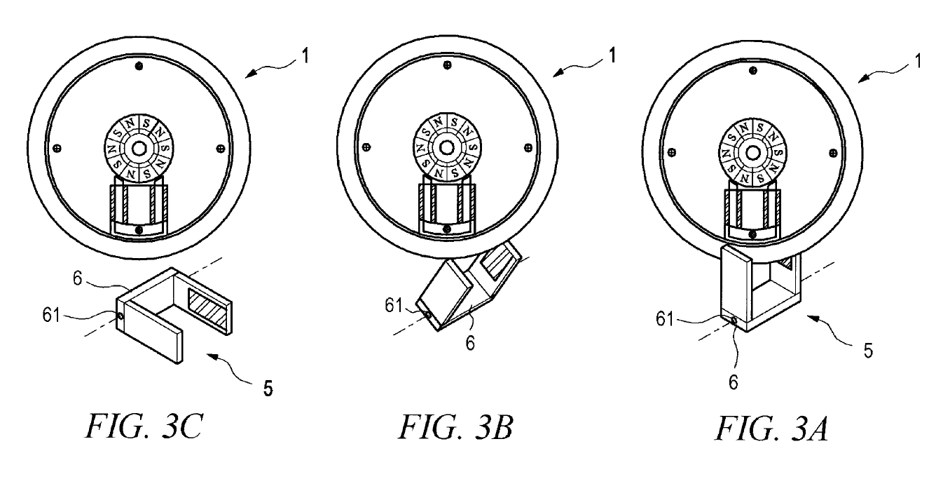

Referring to FIGS. 2A, 2B, 2C, 3A, 3B and 3C, in which the damping wheel 1 is cut into the middle of the slot of the magnetically controlled damper 5, which is turnable right and left about its base axis 61 to make an angular displacement.

The electro-magnetic damping force is induced by cutting the damping wheel 1 into the slot of the magnetically controlled damper 5, whereas the strength of the damping force depends on the depth of the mutually cutting portion so as to regulate the rotational speed of the rotor 2. The larger the mutually cutting portion is, the stronger the electro-magnetic damping force is produced by the brake device.

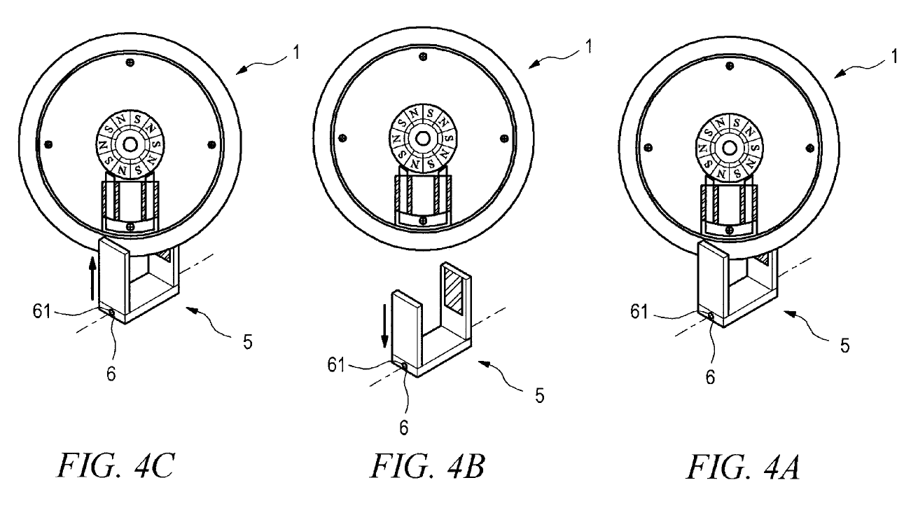

Referring to FIGS. 4A, 4B and 4C, in this first embodiment, the damping wheel 1 cut into the middle of the slot of the magnetically controlled damper 5 is able to linearly displace up and down vertically with respect to its base axis 61 so as to vary the portion mutually cut by the damping wheel 1 and the magnetically controlled damper 5 thereby regulating the rotational speed of the rotor 2.

Similar to the cases illustrated with FIGS. 2A, 2B, 2C and FIGS. 3A, 3B, 3C, the larger the mutually cutting portion is, the stronger the electro-magnetic damping force is produce by the brake device.

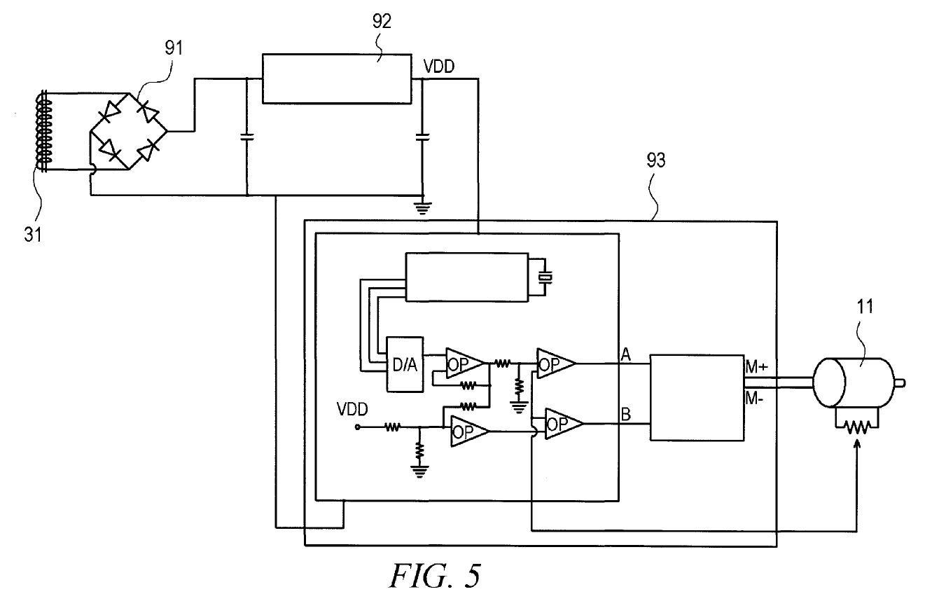

Referrnig to FIG. 5, the electrical circuit diagram of the rectifier and motor control circuit, it shows when the rotor 2 on the damper wheel 1 rotates to cut the fluxes of the magnetic filed excited by the field windings 31, an alternating back emf is induced, and a corresponding alternating current is rectified and its voltage is stabilized through a rectifier 91 and a voltage stabilizer 92 to output the resultant direct current to drive the motor 11 via a control circuit 93.

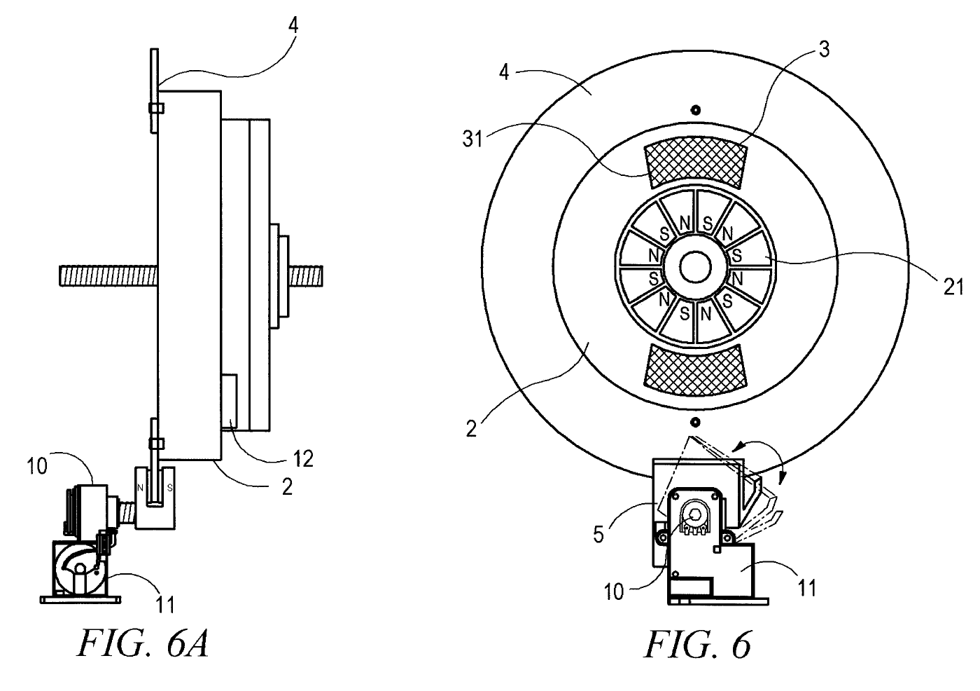

In the second embodiment shown in FIG. 6 and FIG. 6A, the motor 2 is configurated nearly as a circular disc hollow in its middle part to house the stator 3, and the field winding 31 is wound around the stator 3. the permanent magnet 21 is formed on the rotor 2, and the field winding 31 is placed adjacent to the upper and lower edges of the permanent magnet 21 so as to further stabilize the induced back emf of the permanent magnet 21 and the field winding 31. The cast copper rotating part 4 is affixed to the back surface of the rotor 2 such that the cast copper rotating part 4 may work stably. The motor 11 drives the magnetically controlled damper 5 to make a desired linear and angular displacement through the power and motion transmission gear 10.

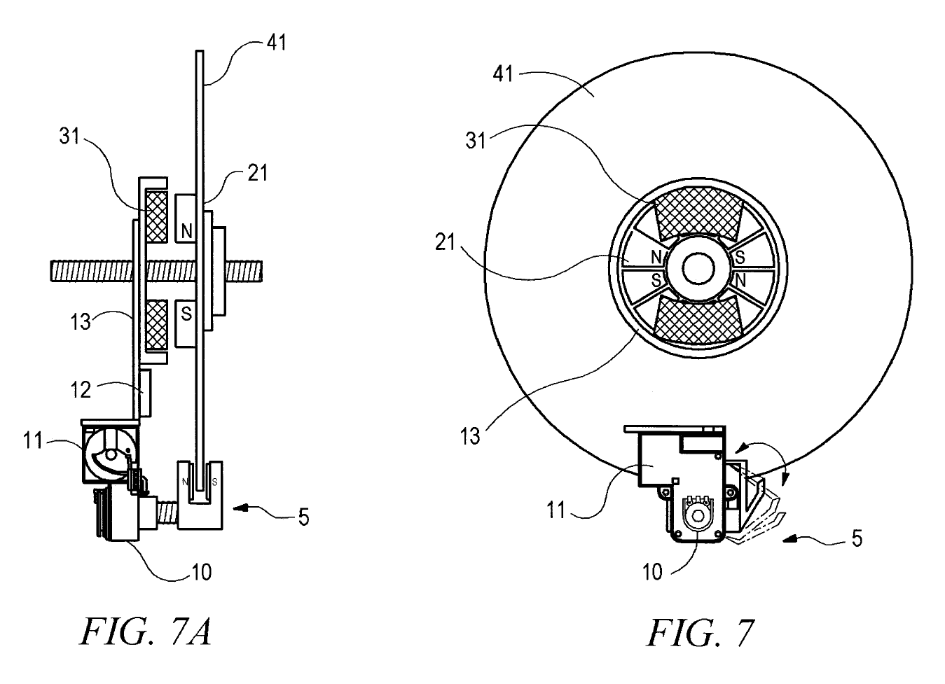

In the third embodiment shown in FIG. 7 and FIG. 7A, the field winding 31 and the permanent magnet 21 are disposed in the way facing with each other so as to save the space of the damper wheel 1. A metallic rotating part 41 is formed integrally in one piece to enhance its structural strength, and it is further stably settled with a rotating part supporter 13 provided behind the field winding 31. The motor 11 is disposed above the power and motion transmission gear 10 and below the rotating part supporter 13. When an alternating emf is induced by the field winding 31, a corresponding alternating current is rectified and stabilized in the rectifier and motor control circuit 12 to supply a stable direct current to drive the motor 11, which in turn actuates the magnetically controlled damper 5 to make a desired linear and angular displacement trough the transmission gear 10.

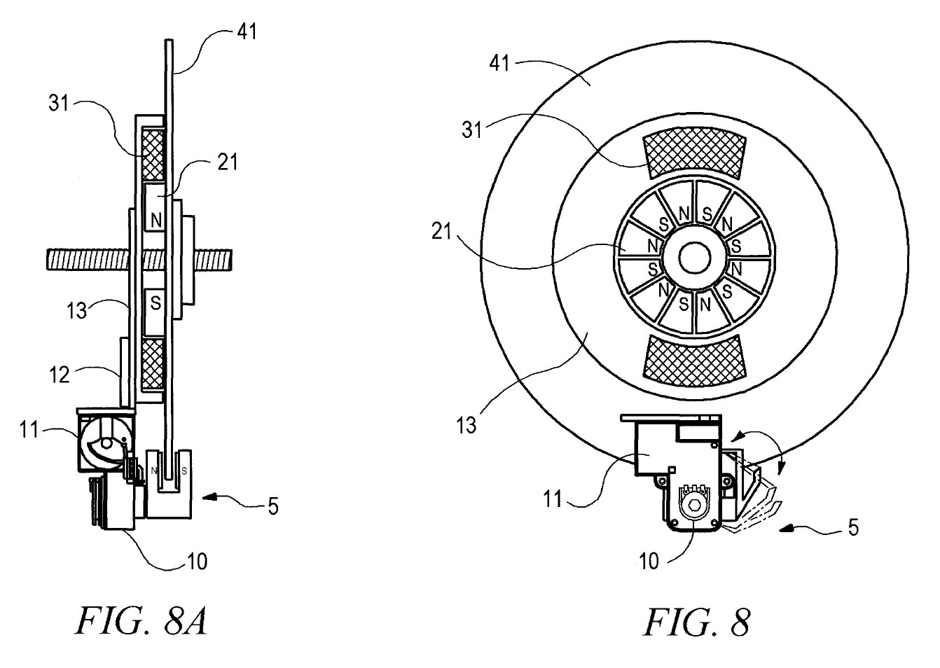

The front and the lateral views of the brake device scheme in the fourth embodiment shown in FIGS. 8, and 8A are substantially similar to that of the third embodiment shown in FIG. 7 and FIG. 7A except the position of the field winding 31. In this embodiment the field winding 31 is disposed in the stator 3 adjacent to the upper and lower edges of the permanent magnet 21 such that they are arrayed along a common longitudinal center line in the lateral view (see FIG. 8A).

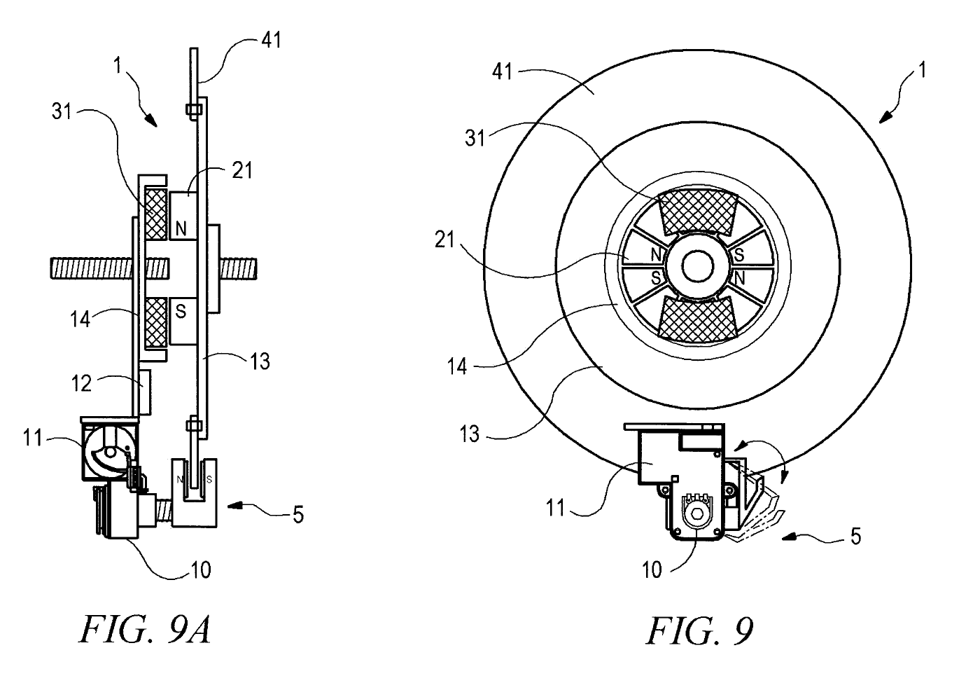

In the fifth embodiment shown in FIGS. 9 and 9A, the middle portion of the metallic rotating part 41 is made hollow so as to save the production cost. The field winding 31 and the permanent magnet 21 are disposed in the way facing with each other so as to save the space of the damping wheel 1. The metallic rotation part 41 is guided by the rotating part supporter 13 at its upper and lower positions such that the metallic rotating part 41 may work stably. A static part supporter 14 and a rotating part supporter 13 are respectively guiding the field winding 31 and the permanent magnet 21 from behind such that the copper damper wheel 1 may work more stably. The motor 11 is disposed above the power and motion transmission gear 10 and below the static part supporter 14. When an alternating emf is induced by the field winding 31, a corresponding alternating current is rectified and stabilized in the rectifier and motor control circuit 12 to supply a stable direct current to drive the motor 11, which in turn actuate the magnetically controlled damper 5 to make a desired linear (including up and down, right and left) and angular displacement through the power and motion transmission gear 10.

The metallic rotating part 41 is made of copper, aluminum or other non-magnetic permeable metallic substance. The static part supporter 14 and the rotating part supporter 13 are made of plastic or metallic material, or the metallic rotating part 41 and the rotating part supporter 13 are formed integrally in one piece of copper, aluminum, or other non-magnetic permeable metallic substance.

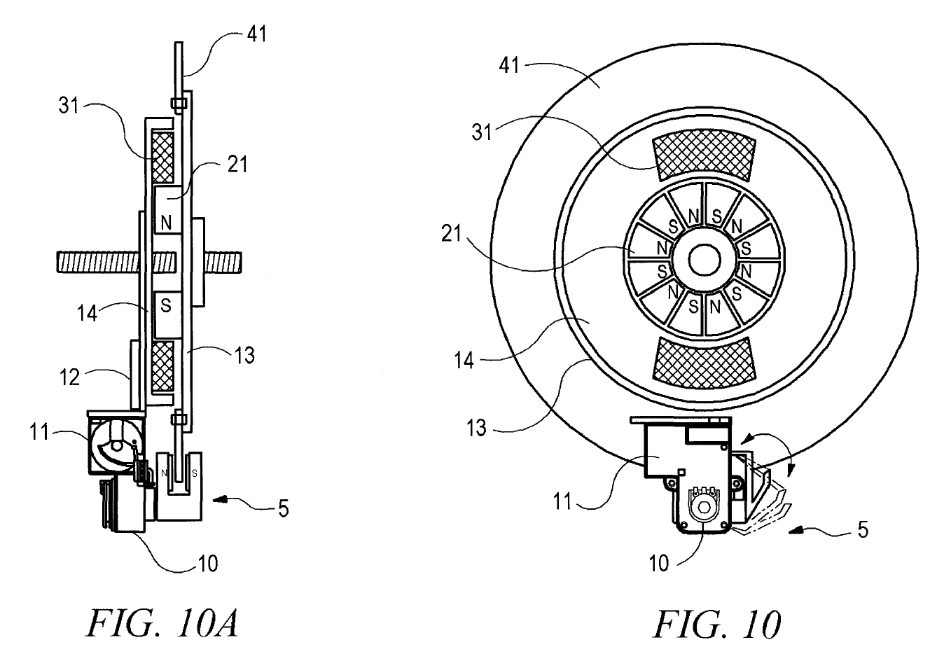

In the sixth embodiment shown in FIGS. 10 and 10A, the structure is substantially similar to that of the fifth one shown in FIGS. 9 and 9A except the position of the field winding 31. In this embodiment the field winding 31 is disposed in the stator 3 adjacent to the upper and lower edges of the permanent magnet 21 such that they are arrayed along a common longitudinal center line in the lateral view (see FIG. 10A).

Many changes and modifications in the above described embodiments of the invention can, of course, be carried out without departing from the scope thereof. Accordingly, to promote the progress in science and the useful arts, the invention is disclosed and is intended to be limited only be the scope of the appended claims.

What is claimed is:

1. A brake device scheme for generating feedback power comprising;
a damper wheel which further including a rotor with even number of pairs of N/S permanent magnet poles disposed in staggering way annularly along its edge, a stator equipped with one or more than one magnetic field winding, and a cast copper rotating part;
a magnetically controlled damper at least composed of a base with right and left walls erected at two sides thereof to form a slot shaped structure, a right and a left intensified magnet attached to the inner surfaces of said right and left walls respectively;
a rectifier and motor control circuit for rectifying and stabilizing an alternating current corresponding to a back electro-motive force (emf) induced by said rotor rotating in said magnetic field winding so as to convert said alternating current into a stabilized direct current;
a motor for outputting a mechanical power;
a power and motion transmission gear driven by said motor to actuate said magnetically controlled damper and said cast copper rotating part; and
a rotating part supporter for stably supporting said cast copper rotating part;
wherein said damper wheel is rotating to cut into the middle cavity of the slot formed by said magnetically controlled damper to induce a varying eddy current whose value is depending on how deep it cuts into said slot of said magnetically controlled damper for damping the rotation of said motor which carries said magnetically controlled damper to make desired up and down, right to left linear displacements and an angular displacement about its base center axis via said power and motion transmission gear.

2. The brake device scheme of claim 1, wherein the construction material of said cast copper rotating part is replaceable with aluminum or other non-magnetic permeable substance.

3. The brake device scheme of claim 1, wherein said stator magnetic field winding is disposed at the place in the front, above, or beneath, right or left, or encircling said permanent magnet poles.

4. The brake device scheme of claim 1, wherein the construction material of said cast copper rotating part is replaceable with copper or aluminum, and said rotating part supporter is made of metallic or non-metallic substance.

5. The brake device scheme of claim 1, wherein said cast copper rotating part and said rotating part supporter are integrally formed in one piece of copper, aluminum, or other non-magnetic permeable substance.

6. The brake device scheme of claim 1, wherein said magnetically controlled damper is able to linearly displace right and left.

7. The brake scheme device of claim 1, wherein said magnetically controlled damper is able to linearly displace up and down.

8. The brake device scheme of claim 1, wherein said magnetically controlled damper is able to make an angular displacement.
